(19) United States
(12) Patent Application Publication
(10) Pub. No.: US 2019/0308148 A1
(43) Pub. Date: Oct. 10, 2019

(54) COMPARTMENTALIZED MIXING CONTAINER AND SYSTEM

(71) Applicants: Stephanie Gaber, Thornhill (CA); Jared Gaber, Thornhill (CA)

(72) Inventors: Stephanie Gaber, Thornhill (CA); Jared Gaber, Thornhill (CA)

(21) Appl. No.: 16/375,612

(22) Filed: Apr. 4, 2019

(30) Foreign Application Priority Data
Apr. 5, 2018 (CA) 3000342

(51) Int. Cl. B01F 13/08; B01F 1/00; B01F 15/00; B01F 15/06

(52) U.S. Cl. CPC B01F 13/0818; B01F 1/0011; B01F 15/0087; A23L 33/40; B01F 2015/062; B01F 2215/0022; B01F 15/065

(57) ABSTRACT

There is disclosed a compartmentalized mixing container having a soluble mix compartment connected between a lid, and a liquid compartment. The soluble mix compartment is configured to separate a soluble mix from a liquid in the liquid compartment while the soluble mix compartment is closed, and to release the soluble mix to the liquid when the soluble mix compartment is opened. After the soluble mix is sufficiently dissolved in the liquid, the resulting liquid mix may be drank from the compartmentalized mixing container, by passing from the liquid compartment, through a pathway in the opened liquid compartment, to the lid and out. The compartmentalized mixing container may include a magnetic stirrer inside the liquid compartment, and a magnetic stirrer base detachably mounted to its bottom, for spinning the magnetic stirrer. There is also disclosed a system for compartmentalizing a soluble mix and a liquid, and stirring the soluble mix and the liquid into a liquid mix to allow a user to drink the liquid mix. The system may include modular components that connect together in various permutations, and a separate docking station. The docking station may be configured to stir and heat the liquid inside of the liquid compartment.

### CROSS-REFERENCE TO RELATED PATENT DOCUMENTS

This patent application claims the benefit of and priority to Canadian Application No. 3,000,342 filed Apr. 5, 2018, the entire contents of which are hereby incorporated herein in its entirety and for all purposes.

### FIELD OF THE INVENTION

The present invention relates to the field of beverage containers for holding liquids and mixtures. More particularly, the present invention relates to drinking bottles having separate compartments for liquids and dissolvable powders.

### BACKGROUND OF THE INVENTION

Many edible products, particularly drinkable beverages, are made by dissolving a powder into a liquid. The rate of dissolution may be increased by shaking or stirring the mixture after combining the powder and the liquid, and/or by increasing the temperature of the mixture.

One example of a drinkable beverage made by combining a powder with liquid is a liquid infant formula, which can be fed to babies instead of milk from their mother. As is well known, liquid infant formula may be prepared, prior to bottle-feeding the baby, by mixing the powdered infant formula into water and shaking, stirring, and/or swirling, the mixture until well combined, with no powder, or clumps of powder remaining in the solution.

Other examples include protein drinks (shakes), meal replacement drinks, nutrition supplement drinks, fiber supplement drinks, sports drinks, energy drinks, flavoured drinks, medicinal drinks, and vitamin drinks, among many others. In most cases, the liquid component of these types of drinkable beverages is water, but may include other liquids, such as for example, milk, fruit juices, and sports drinks, as is well known. The powder component of these types of drinkable beverages, may include any of a number of different ingredients intended to provide the desired dietary, nutritional, flavour, and other characteristics in the resulting drinkable beverage, as is also well known. The powder component is made to be sufficiently dissolvable, in the intended liquid, be it water, milk, or some other liquid, to form a solution, or heterogenous mixture, suitable for drinking. The powder component may have particle or grain sizes ranging from fine to coarse, which may have regular or irregular shapes. Accordingly, the powder component may include powders, pellets, flakes, granules, crystals, and the like.

Once the drinkable beverage is made by mixing the powder and liquid components together, it must be consumed shortly thereafter. For example, it is recommended that liquid infant formula be consumed within two hours of being premixed when at room temperature. Although the time may be extended if the premixed liquid infant formula is refrigerated, doing so or making provisions to do so adds other complications. In particular, the caregiver needs to make provisions for refrigerating the liquid infant formula, maintaining it at a sufficiently cold temperature, and then warming it up just prior to feeding it to the infant. Having to carry the additional paraphernalia to cool and warm the premixed liquid infant formula makes the process all the more inconvenient. Moreover, in view of concerns over bacteria growth, and breakdown of nutrients, it is preferable to reduce the time between preparing the liquid infant formula, and offering it to the infant for consumption. As noted above, it is recommended that liquid infant formula be consumed within two hours of being premixed. These considerations may be equally applicable to other premixed drinkable beverages, including protein drinks (shakes), meal replacement drinks, nutrition supplement drinks, fiber supplement drinks, sports drinks, energy drinks, flavoured drinks, medicinal drinks, and vitamin drinks, among many others.

The need to consume the premixed drinkable beverage, such as liquid infant formula, within a recommended time period is particularly problematic when away from home, or travelling, with an infant, as feeding times are often dictated by the infant's own schedule, which can vary significantly from day to day, rather than a schedule predetermined by the caregiver.

Furthermore, having to deal with measuring, combining, and mixing powders and liquids stored in separate containers, while away from home can be inconvenient, frustrating, and messy.

One attempt to address some of the above noted problems with powder based drinkable beverages was disclosed in U.S. Pat. No. 9,016,488 to Peres. In particular, there was disclosed a compartmentalized baby bottle for storing and selectively introducing a soluble mix to a predetermined quantity of fluid. The Peres baby bottle essentially has two compartments, one for holding a predetermined quantity of fluid, and the second for holding a soluble mix, wherein the two compartments are separated by a selectively isolating mechanism. Rotating one portion of the selectively isolating mechanism relative to a second portion, causes a regulator to linearly reciprocate along a bi-directional longitudinal path centrally passing through the baby bottle, to open and close communication between the two compartments. Thus, when the regulator is opened the fluid and soluble mix can mix. However, a problem with the Peres baby bottle is that the regulator provides a narrow opening for the fluid to pass to and from the compartment containing the soluble mix, which effectively reduces the total volume of the bottle available for mixing by shaking. Furthermore, locating the soluble mix in the very bottom of the baby bottle, and providing only the one regulator opening above, predisposes the soluble mix to being pushed against the walls of the bottom compartment by the fluid during shake mixing by the caregiver, which tends to increase clumping of the wetted soluble mix and sticking of the wetted soluble mix to the walls of the bottom compartment. In other words, the selectively isolating mechanism in the Peres baby bottle interferes with shake mixing, thereby reducing mixing efficiency.

Furthermore, the need to shake the Peres bottle to dissolve the soluble mix in the fluid, ties up or otherwise distracts the caregiver from tending to the infant for a time. Moreover, shaking the bottle to effect the mixing of the fluid and soluble mix to prepare the liquid infant formula can be time consuming, tiring, burdensome, and leave clumps of undissolved powder.

Accordingly, there is a continuing need for improvements in compartmentalized mixing containers and systems.

### SUMMARY OF THE INVENTION

What is desired is an improved compartmentalized mixing container and system which overcomes at least some of the problems associated with the prior art as set forth herein in the detailed description and in the claims.

In this regard, it may be desirable to provide a compartmentalized mixing container having an openable soluble mix compartment for separating a soluble mix from a liquid when the soluble mix compartment is closed, and releasing its contents of soluble mix to a liquid, preferably contained in a liquid compartment attached to the soluble mix compartment, when the soluble mix compartment is opened. Preferably, the soluble mix compartment has openable top and bottom gates which are configured to allow the liquid to pass through the soluble mix compartment when the soluble mix compartment is opened, and the compartmentalized mix container is stirred, shaken, swirled, inverted, or the like. By allowing the liquid to pass through the soluble mix compartment in this way, the liquid may be used to efficiently wash substantially all of the soluble mix contained in the soluble mix compartment into the liquid for quick and efficient dissolving.

Additionally, the preferred compartmentalized mixing container has a magnetic stirrer comprising a magnetic stirrer inside of the liquid compartment, and a magnetic stirrer base detachably mounted to the liquid compartment for spinning the magnetic stirrer inside the liquid compartment to stir the soluble mix and assist with dissolving it in the liquid to form the drinkable liquid mixture.

Accordingly there is disclosed in accordance with one aspect of the present invention, a soluble mix compartment.

According to another aspect of the present invention, there is disclosed a compartmentalized mixing container.

According to yet another aspect of the present invention, there is disclosed a system for compartmentalizing a soluble mix and a liquid, and stirring the soluble mix and the liquid into a liquid mix to allow a user to drink the liquid mix.

The preferred system may include modular components that connect together in various permutations, and a separate docking station. A preferred docking station may enable the user to stir and heat the liquid/liquid mix inside of the liquid compartment.

### BRIEF DESCRIPTION OF THE DRAWINGS

Reference will now be made to the preferred embodiments of the present invention with reference, by way of example only, to the following drawings in which:

FIG. 1 is a front view of a compartmentalized mixing container including a lid, a soluble mix compartment, a liquid compartment, a magnetic stirrer, and a magnetic stir base, according to an embodiment of the present invention;

FIG. 2 is an exploded view of the compartmentalized mixing container of FIG. 1;

FIG. 3 is a front view of the soluble mix compartment of FIG. 1;

FIG. 4 is an exploded view of the soluble mix compartment of FIG. 3;

FIG. 5 is front view of a soluble mix compartment according to another embodiment of the present invention;

FIGS. 6-9 are perspective views of the components of the soluble mix compartment of FIG. 1, in various stages of assembly;

FIG. 10 is a front view of the soluble mix compartment including a replaceable pod, according to another embodiment of the present invention;

FIG. 11 is a front view of the soluble mix compartment of FIG. 10, with the pod being inserted;

FIG. 12 is a perspective view of the soluble mix compartment of FIG. 11, with the pod being inserted;

FIG. 13 is a cross-sectional side view of the pod of FIG. 10;

FIG. 14 is a perspective view of the soluble mix compartment of FIG. 12, after the pod has been inserted, in a closed position;

FIG. 15 is a perspective view of the soluble mix compartment of FIG. 14, in an open position;

FIG. 16 is a perspective view of a prior art magnetic stirrer, usable with an embodiment of the present invention;

FIG. 17 is a perspective view of a magnetic stirrer according to an embodiment of the present invention;

FIG. 18 is a front view of the compartmentalized mixing container of FIG. 1, without the soluble mix compartment connected, and featuring a vertically standing magnetic stirrer, according to an embodiment of the present invention;

FIG. 19 is a bottom view of the compartmentalized mixing container of FIG. 1;

FIG. 20 is a perspective view of a prior art lid, useable with an embodiment of the present invention;

FIG. 21 is a front view of the compartmentalized mixing container of FIG. 1, without the soluble mix compartment or the magnetic stir base connected;

FIG. 22 is a front view of the compartmentalized mixing container of FIG. 1, without the soluble mix compartment connected;

FIG. 23 is a front view of the compartmentalized mixing container of FIG. 1, without the magnetic stir based connected, being inserted into a docking station according to an embodiment of the present invention;

FIG. 24 is a front view of FIG. 23, with the compartmentalized mixing container fully inserted in the docking station;

FIG. 25 is a cross-sectional side view of the magnetic stir base according to another embodiment of the present invention, showing internal components thereof; and

FIG. 26 is a side view of a docking station according to another embodiment of the present invention, showing internal components thereof.

### DETAILED DESCRIPTION OF THE PREFERRED EMBODIMENTS

The present invention is described in more detail with reference to exemplary embodiments thereof as shown in the appended drawing. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein.

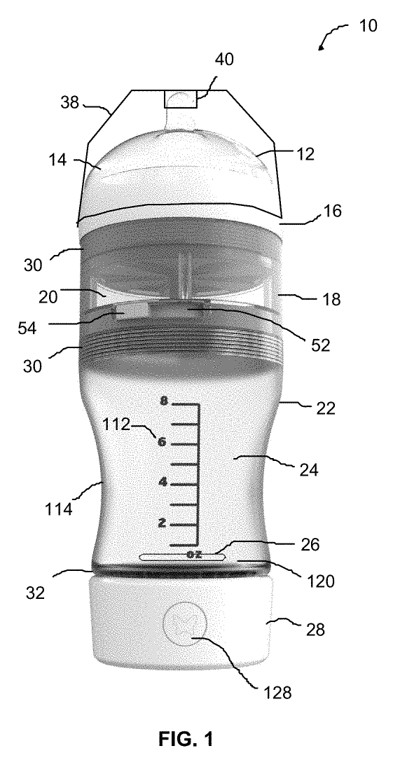

A compartmentalized mixing container 10 according to an embodiment of the present invention is shown in FIG. 1. According to this example, the compartmentalized mixing container 10 is in the form of a baby bottle. However, it will be appreciated that the present invention is not limited to baby bottles, but comprehends other forms including shaker bottles, sports bottles, medicine containers, food containers, and food supplement bottles, all of which are comprehended by the present invention.

As shown, the compartmentalized mixing container 10 has a lid 12, which in this example is configured as a nipple 14 including a fastening ring 16, a soluble mix compartment 18 for releasably holding a soluble mix 20, a liquid compartment 22 for holding liquid 24, a magnetic stirrer 26, and a magnetic stir base 28. Preferably, the components of the compartmentalized mixing container 10 may be releasably attached together using for example threaded connections 30, interference fit connections, bayonet connections, quarter turn connection 32, half turn connection, and combinations thereof. In this way the components may be easily assembled and disassembled to facilitate cleaning of the compartmentalized mixing container 10 between uses.

FIG. 1 shows the lid 12, soluble mix compartment 18, and liquid compartment 22 attached together with threaded connections 30, while the magnetic stir base 28 is attached to the liquid compartment 22 with a quarter turn connection 32, according to a preferred embodiment of the present invention. However, it will be appreciated that the magnetic stir base 28 may also be attached to the liquid compartment 22 by other means, including a threaded connection. Furthermore, it has been found that a smooth aesthetically pleasing profile may be achieved by recessing the inner threads 34 and the outer threads 36 of the threaded connections 30, as best seen in FIG. 1. As will now be appreciated, configuring the inner and outer threads 34, 36 in this way allows the outer walls of adjacent components of the compartmentalized mixing container 10 to be made flush with one another to present a smooth, substantially seamless outer surface along the length of the compartmentalized mixing container 10.

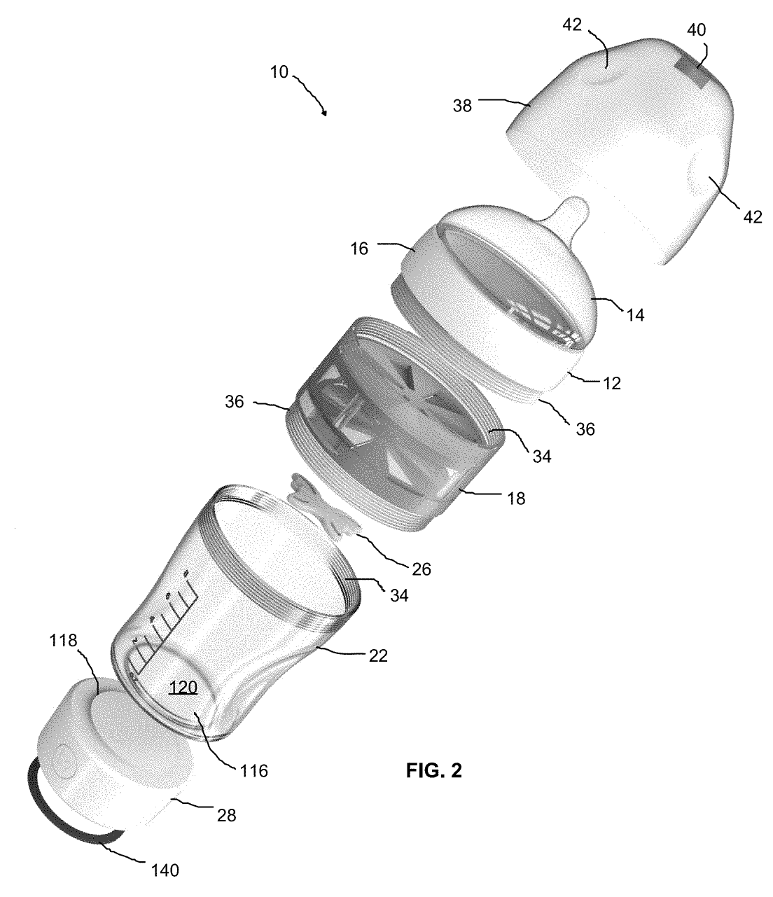

FIG. 2 shows that a cap 38 may also be provided to cover and protect the lid 12 from dirt when the compartmentalized mixing container 10 is not in use. Although preferred, it will be appreciated that the cap 38 may be omitted, according to other embodiments of the present invention. Additionally, the cap 38 may be used to help prevent leakage of liquid from the lid 12. According to the present example, wherein the compartmentalized mixing container 10 is in the form of a baby bottle, and the lid 12 includes a nipple 14, the cap 38 may preferably include a cavity 40 sized and shaped to act as a shield for the tip of the nipple 14. The cavity 40 may preferably also help seal the opening in the nipple to prevent leaking when the compartmentalized mixing container 10 is not in use. The cap 38 may also be provided with gripping means to assist the user with removing the cap 38, preferably using only one hand, such as for example indents 42, as shown in FIG. 2.

With continued reference to FIG. 2, lid 12, is shown as including a nipple 14, sized and shaped to be suitable for feeding an infant. The nipple 14 may be made from rubber, and rubber-like materials, including for example, latex, and silicone, as is known in the art. The nipple 14 is preferably attached to a fastening ring 16 as a one piece component, for ease of washing and attachment to the soluble mix compartment 18 of the compartmentalized mixing container 10. Preferably, the fastening ring 16 may be made from plastic, most preferably a BPA-free plastic. The attachment may be by adhesive, interference fit, or co-molding, for example, as well as other means known in the art. Although the preferred lid 12 is described as a unitary construction of a rubber nipple 14 attached to a fastening ring 16, it is also contemplated that the lid 12 may be constructed from more or fewer parts, and that the parts may need to be assembled together, and permit disassembly, by the user. For example, the nipple 14 may be detachably attached to the fastening ring 16, to allow the user to repair the lid 12, by replacing broken, worn or dirty parts, instead of discarding the entire lid 12. All such embodiments are comprehended by the present invention.

The bottom of the lid 12, for example, the bottom of the fastening ring 16, preferably includes outer threads 36 configured to form a threaded connection 30 with inner threads 34 on the top of the soluble mix compartment 18. As mentioned above, the inner and outer threads 34, 36 are recessed according to a preferred embodiment of the present invention, to allow the outer surfaces of the lid 12 and the soluble mix compartment 18 to be made flush with one another to present a smooth, substantially seamless outer surface across the threaded connection 30. It will be appreciated that the positioning of the recessed inner and outer threads 30, 32 may be reversed to achieve the flush threaded connection 30 between the lid 12 and the soluble mix compartment 18.

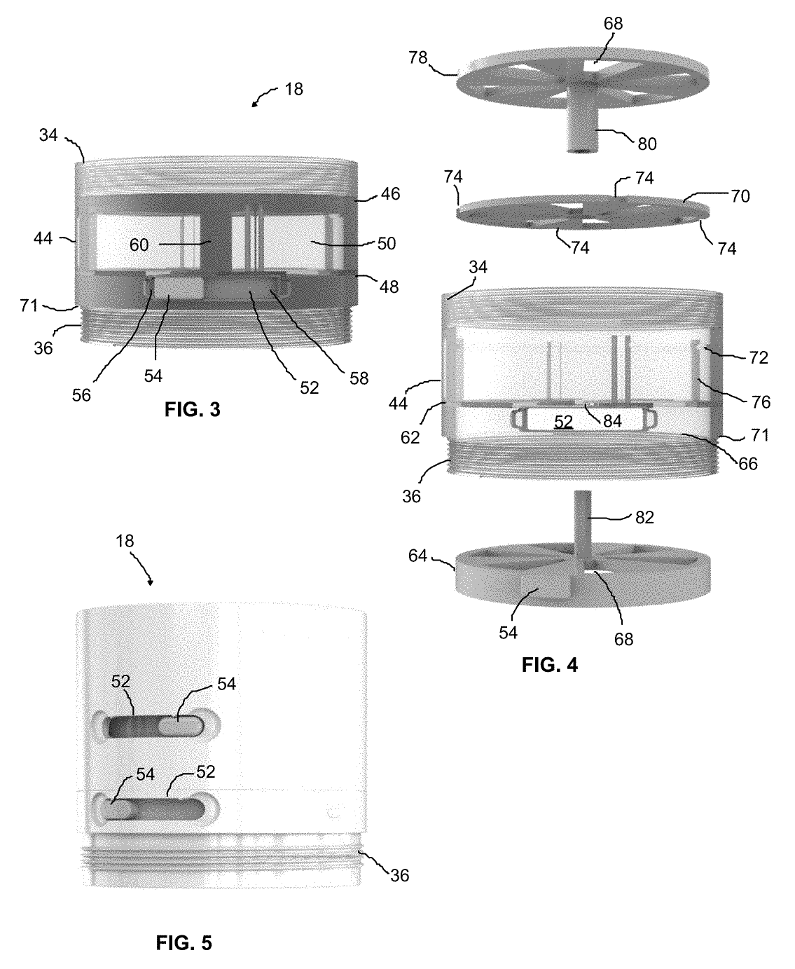

With reference to FIGS. 3 and 4, the soluble mix compartment 18 preferably has a body 44. The body 44 is preferably made from plastic, most preferably a BPA-free plastic. However, the body 44 may be made from many other materials as will be appreciated by persons skilled in the art, including for example, glass, aluminium, and stainless steel, for example. The preferred body 44 may be clear, or sufficiently see-through to allow the user to determine the level of the soluble mix 20 contained in the soluble mix compartment 18. However, the body 44 may be made to be opaque according to other embodiments of the present invention. Further, the body 44, may be made to be opaque, but incorporate one or more see-through portions to still allow the user to determine the level of soluble mix 20 contained in the soluble mix compartment 18. All such embodiments are comprehended by the present invention.

As shown in FIGS. 3 and 4, the body 44 of the soluble mix compartment 18 is preferably cylindrical in shape and contains a top gate 46 and a bottom gate 48, defining a soluble mix chamber 50 there between. The soluble mix chamber 50 may preferably be sized and shaped to hold a sufficient amount of soluble mix 20 to solubilize in an amount of liquid 24 that may be contained in the liquid compartment 22. By way of example, the soluble mix chamber 50 may be sized and shaped to hold soluble mix 20 in a range of 0.5-9.5 fluid oz. For example, a soluble mix chamber 50 configured as a baby bottle may be sized and shaped to hold soluble mix 20 in a range of 0.5-3.5 fluid oz, while a soluble mix chamber 50 configured as a sports bottle may be sized and shaped to hold soluble mix 20 in a range of 2-9.5 fluid oz.

As discussed in more detail below, the top and bottom gates 46, 48 are preferably configured to contain the soluble mix 20 until just prior to the user's desire to drink the liquid mix, at which point the user opens the top and bottom gates 46, 48 thereby releasing the soluble mix 20 from the soluble mix chamber 50 into the liquid 24 contained in the liquid compartment 22, to allow mixing of the soluble mix 20 and the liquid 24 to form the liquid mix. Additionally, the top and bottom gates 46, 48, when opened form a passageway through the soluble mix compartment 18, between the liquid compartment 22 and the lid 12, to allow the liquid mix therethrough, to be drank by the user. As discussed in more detail below, the top gate 46 preferably includes a top fixed gate member 70 and a top slidable gate member 78, while the bottom gate 48 preferably includes a bottom fixed gate member 62 and a bottom slidable gate member 64.

The purpose of the top gate 46 is to prevent the soluble mix 20 from spilling out of the soluble mix chamber 50 into the lid 12. If there is any moisture on the walls of the lid 12, the soluble mix 20 coming into contact with the moisture will be wetted prematurely. The prematurely wetted soluble mix 20 could potentially clog the nipple 14, or allow bacterial growth which could contaminate the liquid mix. Accordingly, inclusion of the top gate 46 helps prevent these issues from developing. However, the top gate 46 may be omitted in other embodiments of the invention, or if spilling of the soluble mix 20 from the soluble mix chamber 50 into the lid 12 may be deemed acceptable. The purpose of the bottom gate 48 is to prevent the soluble mix 20 from being prematurely released into the liquid 24 contained in the liquid compartment 22. Preferably, the bottom gate 48 may also be liquid tight, thereby prevent the liquid 24 from seeping into the soluble mix chamber 50 and prematurely wetting the soluble mix 20 contained therein.

According to an embodiment of the present invention, the body 44 has an elongate side wall opening 52, and the bottom gate 48 has a handle 54 extending from its side, such that the handle 54 protrudes through the elongate side wall opening 52 sufficiently to be engaged by the user. In this way, the user may push or pull the handle 54 with his or her finger to slide the handle 54 in the elongate side wall opening 52 from one end 56 to the other end 58 to open and close the bottom gate 48. It will be appreciated that the bottom gate 48 will preferably be configured to sealingly cover the elongate side wall opening 52 as the handle 54 is slid between the one and the other ends 56, 58, as discussed in more detail below.

If both top and bottom gates 46, 48 are included in the body 44, a linking member 60 may preferably be provided to connect the top and bottom gates 46, 48, such that sliding the handle 54 to close or open the bottom gate 48 may be translated to the top gate 46, so that both the top and bottom gates 46, 48 may be opened and closed simultaneously by sliding the handle 54 on the bottom gate 48. As shown in FIGS. 3 and 4, the linking member 60 may, for example, be centrally located and extending between the top and bottom gates 46, 48. As another example, the linking member 60 may be peripherally located and extending between the top and bottom gates 46, 48 (not shown). Moreover, more than one linking member 60 may be provided according to some embodiments of the present invention (not shown). Although the above example describes a handle 54 on the bottom gate 48, it is contemplated that the handle 54 may be provided instead on the top gate 46, with a matching elongate side wall opening 54 on the body 44, in embodiments including the top gate 46, and that opening and closing of the bottom gate 48 may be effected via the centrally located linking member 60, in a manner similar to the one discussed above. It is also contemplated that each of the top and bottom gates 46, 48 may be opened and closed independently of one another, by providing separate handles 54, to protrude through separate elongate side wall openings 52, and omitting a linking member 60 altogether, as shown by way of example in FIG. 5. All such embodiments are comprehended by the present invention.

FIG. 4 shows the soluble mix compartment 18 disassembled into its separate components, according to an embodiment of the present invention. Disassembly of the separate components is preferred to facilitate cleaning. The bottom gate 48 preferably comprises a bottom fixed gate member 62 that is permanently attached to the body 44 above the elongate side wall opening 52, and a bottom slidable gate member 64 that is removably insertable into position through the bottom of the body 44. The bottom fixed gate member 62 is preferably rigid, and formed unitarily with the body 44. The bottom slidable gate member 64 is preferably made from a material such as rubber, rubber-like material, plastic, silicone, and sufficiently flexible to allow the bottom slidable gate member 64 to be pressed into position through a retaining collar or ledge 66 extending from the inside wall of the body to maintain the bottom slidable gate member 64 pressed against the bottom fixed gate member 62. As mentioned above, the handle 54 may preferably be provided on the bottom slidable gate member 64 to extend from its side, such that the handle 54 protrudes through the elongate side wall opening 52 sufficiently to be engaged by a user. Preferably, the bottom fixed gate member 64 is removably insertable in the bottom end of the body 44 and may be supported by a supporting collar or ledge 71 extending from the inner wall of the body 44. Preferably, at least a portion of the side wall of the bottom slidable gate member 64 is sized and shaped to sealingly cover the elongate side wall opening 52 as the handle 54 is slid between the one and the other ends 56, 58. Most preferably, the entire side wall of the bottom slidable gate member 64 is sized and shaped to effect a liquid tight seal against the inner wall of the body 44, and across the elongate side wall opening 52.

The bottom fixed gate member 62 and the bottom slidable gate member 64 each have one or more gate openings 68. Preferably, the gate openings 68 may be substantially triangular in shape, although other shapes are comprehended by the present invention, including circular, elliptical, square, rectangular, and slits. The gate openings 68 may be misaligned by sliding the bottom slidable gate member 64 in the body 44 in one direction relative to the bottom fixed gate member 62.

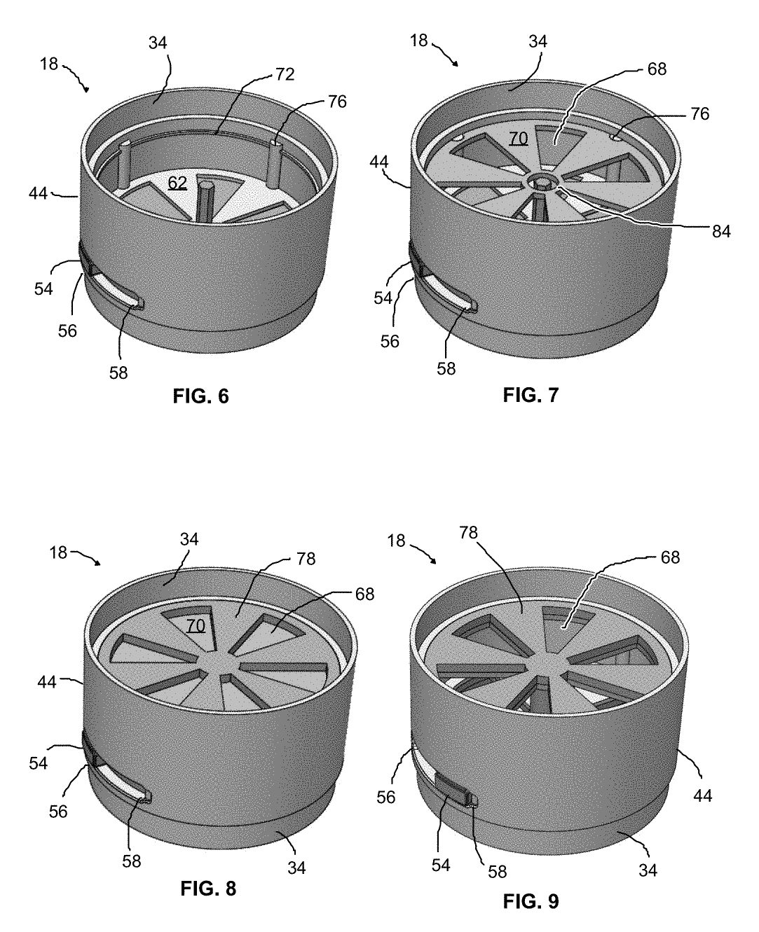

FIG. 6 shows the bottom slidable gate member 64 inserted in the body 44 to form the bottom gate 48. The handle 54 is slid to be positioned at the one end 56 of the elongate side wall opening 52, causing the bottom gate 48 to be in the closed position, as evidenced by the fact that the gate openings 68 of the bottom slidable gate member 64 and the bottom fixed gate member 62 being misaligned. In this example, the bottom slidable gate member 64 rotatably slides against the bottom fixed gate member 62 to misalign the gate openings 68, when the handle 54 is slid to the one end 56 of the elongate side wall opening 52. On the other hand, the gate openings 68 are aligned when the bottom slidable gate member 64 is slid in the body 44 relative to the bottom fixed gate member 62. In this example, the bottom slidable gate member rotatably slides against the bottom fixed gate member 62 to align the gate openings 68, when the handle 54 is slid to the other end 58 of the elongate side wall opening 52.

It will now be appreciated that when the gate openings 68 are misaligned, the bottom gate 48 is closed, thereby preventing soluble mix 20 contained in the soluble mix chamber 50 from passing through the bottom gate 48. Accordingly, when the compartmentalized mixing container 10 is assembled with the soluble mix compartment 18, with the bottom gate 48 closed, the soluble mix 20 will be blocked from passing into the liquid 24 contained in the liquid compartment 22, and preferably, the liquid 24 contained in the liquid compartment 22 will be blocked from passing into the soluble mix compartment 18 and wetting the soluble mix 20. Then, when the bottom gate 48 is opened, the soluble mix 20 may be released through the bottom gate 48 into the liquid 24 contained in the liquid compartment 22.

In embodiments where the top gate 46 is present, it may preferably comprise a top fixed gate member 70 and a top slidable gate member 78. Preferably, the top fixed gate member 70 is removably insertable in the top end of the body 44 and supported by a supporting collar or ledge 72 extending from the inner wall of the body 44, as shown in FIGS. 6 and 7. The top fixed gate member 70 is preferably rigid, and formed from the same or similar plastic as the body 44. The top fixed gate member 70 preferably includes one or more notches or grooves 74 about its periphery that are sized and shaped to engage with projections or guide rails 76 provided along the inner wall of the body 44. Although, in the example shown, the body 44 includes four guide rails 76, and the top fixed gate member includes four matching grooves 74, it will be appreciated that more or fewer grooves 74 and guide rails 76 may be provided in accordance with the present invention. The grooves 74 and guide rails 76 serve two functions. The first function is to fix the top fixed gate member 70 from rotating with the top slidable gate member 78, and the second function is to correctly align the top fixed gate member 70, so that the top gate 46 will open and close correctly in synch with the opening and closing of the bottom gate 48, when the top and bottom gates 46, 48 are connected by the linking member 60. Preferably, the grooves 74 and guide rails 76 may be configured to limit the number of possible alignments, most preferably the number of possible alignments may be limited to one desired alignment.

It is also contemplated that the bottom fixed gate member 62 may be a separate component, like the top fixed gate member 70 discussed above, so that it may also be removable for cleaning. According to such an embodiment, the bottom fixed gate member 62 may also include one or more notches or grooves (not shown), and the body 44 may also be provided with matching projections or guide rails (not shown) along the inner wall of the body 44 to fix the bottom fixed gate member 62 from rotating with the bottom slidable gate member 64.

As shown in FIG. 4, when included, the top slidable gate member 78 may preferably be inserted in the top end of the body 44 over the top fixed gate member 70. FIG. 8 shows the top slidable gate member 78 in position in the body 44 over the top fixed gate member 70. The top slidable gate member 78 is preferably made from a material such as silicone, and sufficiently flexible to allow the top slidable gate member 70 to be pressed into position in the top of the body 44. The top slidable gate member 78 will preferably be maintained in position against the top fixed gate member 70 by the bottom edge of the lid 12, when the threaded connection 30 is made therebetween, and/or and interference fit connection between the linking post receptacle 80 of the top slidable gate member 78 and the linking post 82 of the bottom slidable gate member 64. Preferably, as shown in this example, the bottom edge of the recessed outer threads 36 of the lid 12 may be configured to impinge on the top slidable gate member 78, about its periphery, when the threaded connection 30 is made.

As in the case of the bottom gate 48 discussed above, the top fixed gate member 70 and the top slidable gate member 78 of the top gate 46, each have one or more gate openings 68. Preferably, the gate openings 68 may be triangular in shape, although other shapes are comprehended by the present invention, including circular, elliptical, square, rectangular, and slits. The gate openings 68 are misaligned when the top slidable gate member 78 is slid in the body 44 relative to the top fixed gate member 70.

FIG. 8 shows the top slidable gate member 78 inserted in the body 44 over the top fixed gate member 70 to form the top gate 46. The handle 54 is slid to be positioned at the one end 56 of the elongate side wall opening 52, causing both the top and bottom gates 46, 48 to be in the closed position, as evidenced by the fact that the gate openings 68 of the top slidable gate member 78 and the top fixed gate member 70 being misaligned. In this example, the top slidable gate member 78 rotatably slides against the top fixed gate member 70 to misalign the gate openings 68, when the handle 54 is slid to the one end 56 of the elongate side wall opening 52.

Preferably, the top and bottom slidable gate members 78, 64 are connected together by a linking member 60, comprising a linking post receptacle 80 extending from the top slidable gate member 78 for engaging a linking post 82 extending from the bottom slidable gate member 64. The top and bottom fixed gate members 70, 62 include apertures 84 sized and shaped to allow the linking post 82 and linking post receptacle 80 to pass through, respectively, and connect to one another. Connecting the top slidable gate member 78 to the bottom slidable gate member 64 via the linking member 60 in this way, enables the top slidable gate member 78 to rotatably slide in the body 44 simultaneously with the bottom slidable gate member 64, when the handle 54 of the bottom slidable gate member 64 is slid to the one end 56 of the elongate side wall opening 52.

The gate openings 68 of the top gate 46 may be aligned by sliding the top slidable gate member 78 in the body 44 relative to the top fixed gate member 70, simultaneously with the bottom slidable gate member 64, by sliding the handle 54 of the bottom slidable gate member 64 to the other end 58 of the elongate side wall opening 52, as shown in FIG. 9. When the gate openings 68 are misaligned, the top gate 46 is closed, thereby preventing soluble mix 20 contained in the soluble mix chamber 50 from passing through the top gate 46. Accordingly, when the compartmentalized mixing container 10 is assembled with the soluble mix compartment 18, with the top gate 46 closed, the soluble mix 20 will be blocked from passing into the lid 12, which might otherwise cause clogging of the nipple 14. Then, when the top gate 46 is opened, preferably at the same time as opening of the bottom gate 48, the liquid 24 may be passed through the soluble mix compartment 18, by tilting, or inverting the compartmentalized mixing container 10. It has been found that allowing the liquid 24 to pass through the soluble mix compartment 18, between the lid 12 and the liquid compartment 22. Such a flowthrough configuration of the soluble mix compartment 18 allows the user to repeatedly pass the liquid 24 through the soluble mix chamber 50 by stirring, shaking, tilting or inverting the compartmentalized mixing chamber 10, to generate a washing action that brings most of the soluble mix 20 into the liquid 24, and dislodges any soluble mix 20 that may be sticking to the walls of the soluble mix compartment 18.

As best seen in FIGS. 2 and 3, the bottom of the soluble mix compartment 18 preferably includes outer threads 36 configured to form a threaded connection 30 with inner threads 34 on the top of the liquid compartment 22. As mentioned above, the inner and outer threads 34, 36 are recessed according to a preferred embodiment of the present invention, to allow the outer walls of the soluble mix compartment 18 and the liquid compartment 22 to be made flush with one another to present a smooth, substantially seamless surface across the threaded connection 30.

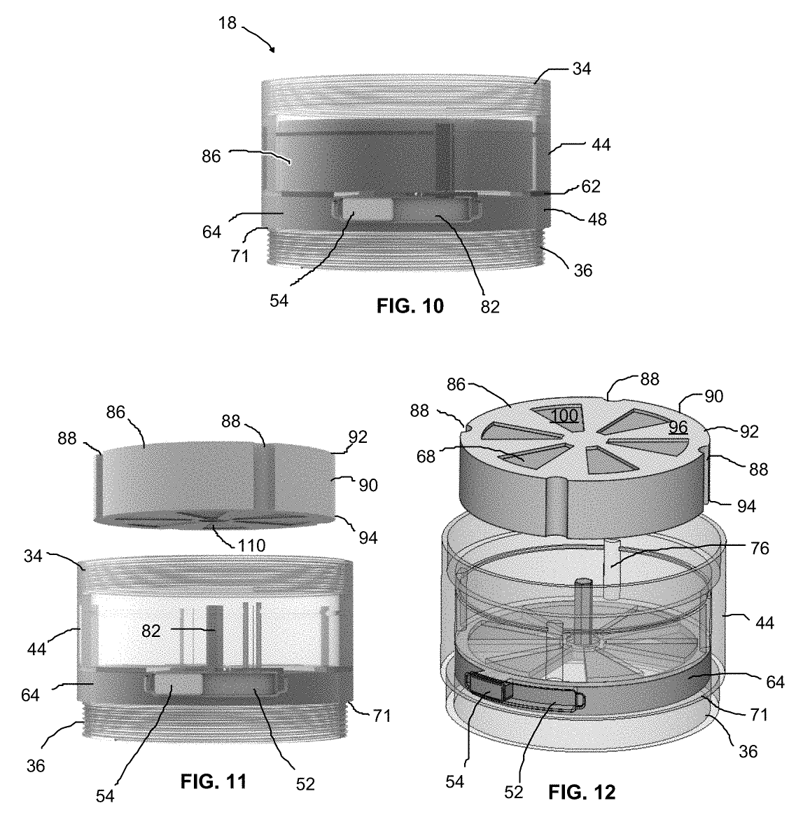

As will now be appreciated, the above described soluble mix compartment 18 is configured to be refillable with soluble mix 20 by the user. However, according to another embodiment of the present invention, the soluble mix compartment 18 may be configured to be used with replaceable pods 86 containing soluble mix 20, including disposable pods, and refillable reusable pods. An example of a soluble mix compartment 18 holding a replaceable pod 86 is shown in FIG. 10. As can be seen, the soluble mix compartment 18 has a body 44, a bottom gate 48, and a pod 86. Inner threads 34 and outer threads 36 are provided at the top and bottom of the body 44, for forming threaded connections 30 to the lid 12 and the liquid compartment 22, as previously described. The top gate 46 is omitted from the soluble mix compartment 18.

As shown in FIGS. 10 and 11, the pod 86 is preferably inserted into the body 44 from the top, to seat on the bottom fixed gate member 62, with the linking post 82 of the bottom slidable gate member 64 engaging a linking post receptacle 110 in the middle of the pod 86. Preferably, the pod 86 includes one or more notches or grooves 88 about its periphery that are sized and shaped to engage with projections or guide rails 76 provided along the inner wall of the body 44. Although, in the example shown, the body 44 includes four guide rails 76, and the pod 86 includes four matching grooves 74, it will be appreciated that more or fewer grooves 88 and guide rails 76 may be provided in accordance with the present invention. The grooves 88 and guide rails 76 serve two functions. The first function is to fix the pod 86 from rotating with the bottom slidable gate member 64, and the second function is to correctly align the pod 86, so that it will open and close correctly in synch with the opening and closing of the bottom gate 48, when the linking post receptacle 110 of the pod 86 is connected to the linking post 82 of the bottom slidable gate member 64. Preferably, the grooves 88 and guide rails 76 may be configured to limit the number of possible alignments, most preferably the number of possible alignments may be limited to one desired alignment. The pod 86 will preferably be retained in position in the body 44 by the bottom edge of the lid 12, when the threaded connection 30 is made therebetween. It will be appreciated that in this example, the bottom edge of the recessed outer threads 36 of the lid 12 will impinge on the top of the pod 86, about its periphery, when the threaded connection 30 is made.

As best seen in FIG. 12 the pod 86 has a housing 90 including top and bottom pod gates 92, 94, with soluble mix 20 contained therebetween. The top and bottom pod gates 92, 94 each have a fixed pod gate member 96, 98, and a slidable pod gate member 100, 102. Preferably, the top and bottom pod fixed gate members 96, 98 are formed in the top and bottom of the housing 90. The top and bottom pod fixed gate members 96, 98 may preferably each have one or more gate openings 68. Preferably, the gate openings 68 may be substantially triangular in shape, although other shapes are comprehended by the present invention, including circular, elliptical, square, rectangular, and slits.

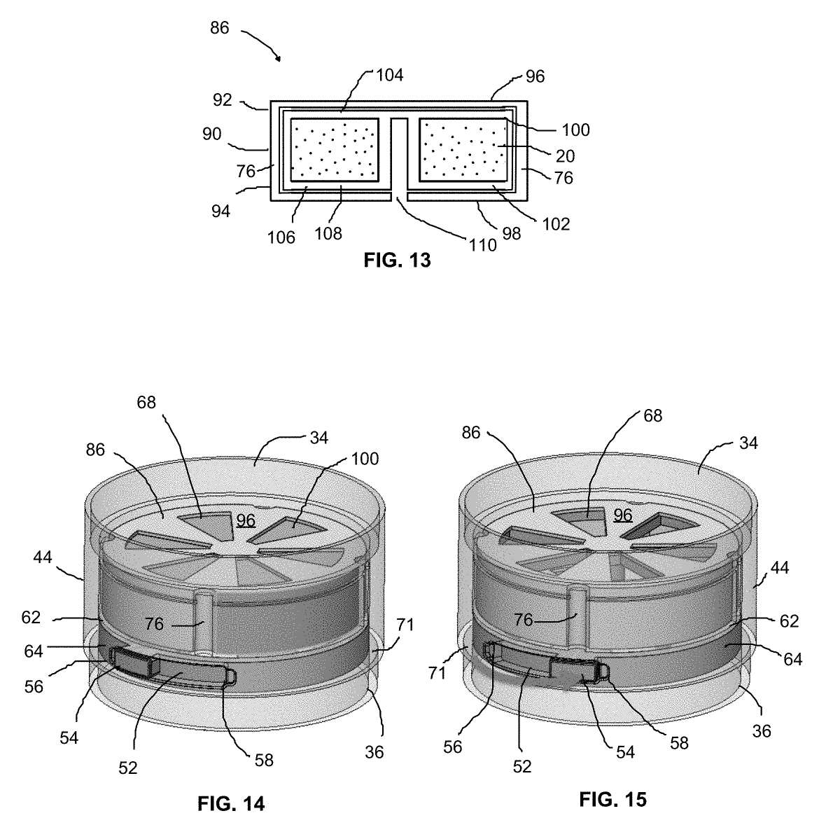

According to a preferred embodiment of the present invention, the slidable pod gate members 100, 102 may be formed in top and bottom ends 104, 106 of a spindle 108 carried within the housing 90, as shown in FIG. 13. In this example, the pod 86 is provided in the closed position, such that the gate openings 68 provided in the top and bottom ends 104, 106 are misaligned with the gate openings 68 in the top and bottom of the housing 90, and inserted into the body 44 of the soluble mix compartment 18, as shown in FIG. 12. As shown in FIG. 14 the pod 86 is fully inserted in the soluble mix compartment 18, with the linking post 82 of the bottom slidable gate member 64 engaging a linking receptacle 110 in spindle 108 of the pod 86. In this configuration, the pod 86 is ready to be switched into the open position to release the soluble mix 20 contained in the pod 86. As shown in FIG. 15, sliding the handle 54 of the bottom slidable gate member 64 to be positioned at the other end 58 of the elongate side wall opening 52, causes the spindle 108 to rotate within the housing 90. The housing 90 is prevented from rotating with the spindle 108 by the guide rails 76, provided along the inner wall of the body 44, engaging the grooves 88 in the housing 90 of the pod 86. The spindle 108 rotates within the housing 90 until the gate openings 68 in the top and bottom slidable pod gate members 100, 102 are aligned with the gate openings 68 in the top and bottom fixed pod gate members 96, 98, thereby opening the top and bottom pod gates 92, 94. In this example, sliding the handle 54 of the bottom slidable gate member 64 rotatably slides the spindle 108 within the housing 90. The gate openings 68 are misaligned when the handle 54 is slid to the one end 56 of the elongate side wall opening 52. On the other hand, the gate openings 68 are aligned when the handle 54 is slid to the other end 58 of the elongate side wall opening 52.

Accordingly, when the compartmentalized mixing container 10 is assembled with the pod 86 in the soluble mix compartment 18, when the bottom gate 48 is closed, the soluble mix 20 will be blocked from passing into the liquid 24 contained in the liquid compartment 22, and preferably, the liquid 24 contained in the liquid compartment 22 will be blocked from passing into the soluble mix compartment 18 and wetting the soluble mix 20 contained in the pod 86. Then, when the bottom gate 48 is opened, the top and bottom pod gates 92, 94 will simultaneously open, releasing soluble mix 20 through the bottom pod gate 94, and the bottom gate 48 into the liquid 24 contained in the liquid compartment 22. Furthermore, with the bottom gate 48, and both top and bottom pod gates 92, 94 open, the liquid 24 may be passed through the soluble mix compartment 18, by tilting, or inverting the compartmentalized mixing container 10.

Preferably, the pod 86, including the housing 90 and the spindle 108 may be mode from plastic, most preferably a BPA-free plastic.

The liquid compartment 22 is preferably sized and shaped substantially in the form of a graduated cylinder for holding liquids 24, as shown in FIGS. 1 and 2. The liquid compartment 22 is preferably made from a plastic, most preferably BPA-free plastic. However, the liquid compartment 22 may be made from many other materials as will be appreciated by persons skilled in the art, including for example, glass, aluminium, and stainless steel, for example. The preferred liquid compartment 22 will be clear, or sufficiently see-through to allow the user to determine the level of the liquid 24 contained in the liquid compartment 22. However, the liquid compartment 22 may be made to be opaque according to other embodiments of the invention. Further, the liquid compartment 22, may be made to be substantially opaque, but incorporate one or more see-through portions to still allow the user to determine the level of liquid 24 contained in the liquid compartment 22. To assist the user with determining the level of liquid 24 contained in the liquid compartment 22, the liquid compartment 22 may be provided with graduated markings 112. All such embodiments are comprehended by the present invention.

Preferably, the liquid compartment 22 may be sized to hold a sufficient volume of liquid 24 to solubilize an amount of soluble mix 20 that may be contained in the soluble mix compartment 18, and shaped to allow the liquid 24 to be agitated or stirred to mix the soluble mix 20 into the liquid mix. By way of example, the liquid compartment 22 may be sized and shaped to hold liquid 24 in a range of 2 to 34 fluid oz. For example, a liquid compartment 22 of a compartmentalized mixing container 10 configured as a baby bottle may be sized and shaped to hold liquid 24 in a range of 2 to 8 fluid oz, while a liquid compartment 22 of a compartmentalized mixing container 10 configured as a sports bottle may be sized and shaped to hold liquid 24 in a range of 12 to 34 fluid oz. Preferably, the liquid compartment 22 may include hand holds to allow the user to more easily hold the compartmentalized mixing container 10 when in use. By way of example, the hand holds may include one or more depressions 114 in the walls of the liquid compartment 22, as shown in FIG. 2. Other examples, include protrusions, ribs, ridges, grooves, and combinations. A further example of a hand hold may include anti-skid material, such as an attached rubber strip or the like.

As shown in FIG. 2, the open top of the liquid compartment 22 preferably includes inner threads 34 configured to form a threaded connection 30 with outer threads 36 on the bottom of the soluble mix compartment 18. Most preferably, the inner threads 34 of the open top of the liquid compartment 22 will also be configured to from a threaded connection 30 with the lid 12. As mentioned above, the inner and outer threads 34, 36 are recessed according to a preferred embodiment of the present invention, to allow the outer walls of the soluble mix compartment 18 and the liquid compartment 22 to be made flush with one another to present a smooth, substantially seamless surface across the threaded connection 30. Similarly, the recessed inner and outer threads 34, 36 allow the outer walls of the lid 12 and the liquid compartment 22 to be made flush with one another to present a smooth, substantially seamless surface across the threaded connection 30, when the soluble mix compartment 18 is not being used.

The closed bottom of the liquid compartment 22 preferably includes a means for releasably attaching the magnetic stir base 28. As shown in FIG. 2, the preferred attachment means is a round recess 116 in the bottom of the liquid compartment 22, configured to matingly receive a round projection 118 on the top of the magnetic stir base 28, and effect a releasable quarter turn connection 32. It will be appreciated that the releasable quarter turn connection 32 may be reversed by providing the round projection 118 in the bottom of the liquid compartment 22, and the round recess 116 in the magnetic stir base 28. Furthermore, the magnetic stir base 28 may be attachable to the liquid compartment 22 by other attachment means known in the art, including a threaded connection 30, an interference fit connection, or even an adhesive if it is desired to make the connection permanent. However, in a preferred embodiment of the invention, the floor 120 of the liquid compartment 22 will be flat, and sized to allow a magnetic stirrer 26 to spin on the floor 120, to stir the liquid 24, when driven by the magnetic stir base 28, as discussed in more detail below. All such embodiments are comprehended by the present invention.

The magnetic stir base 28 is preferably detachably mountable to the bottom of the liquid compartment 22, as mentioned above. Preferably, the magnetic stir base 28 is configured to magnetically hold the magnetic stirrer 26 to the floor 120 of the liquid compartment 22 and to spin the magnetic stirrer 26 to stir the liquid 24 and the soluble mix 20 released from the soluble mix compartment 18 into the liquid 24 to dissolve the soluble mix 20 and form the liquid mix so that it may be readied for drinking. Furthermore, it is contemplated that the magnetic stirrer 26 may be used to mix pureed food, such as for example pureed baby food, if the soluble mix compartment is not in use, or in embodiments that do not include the soluble mix compartment 18, such as food containers. All such embodiments are comprehended by the present invention.

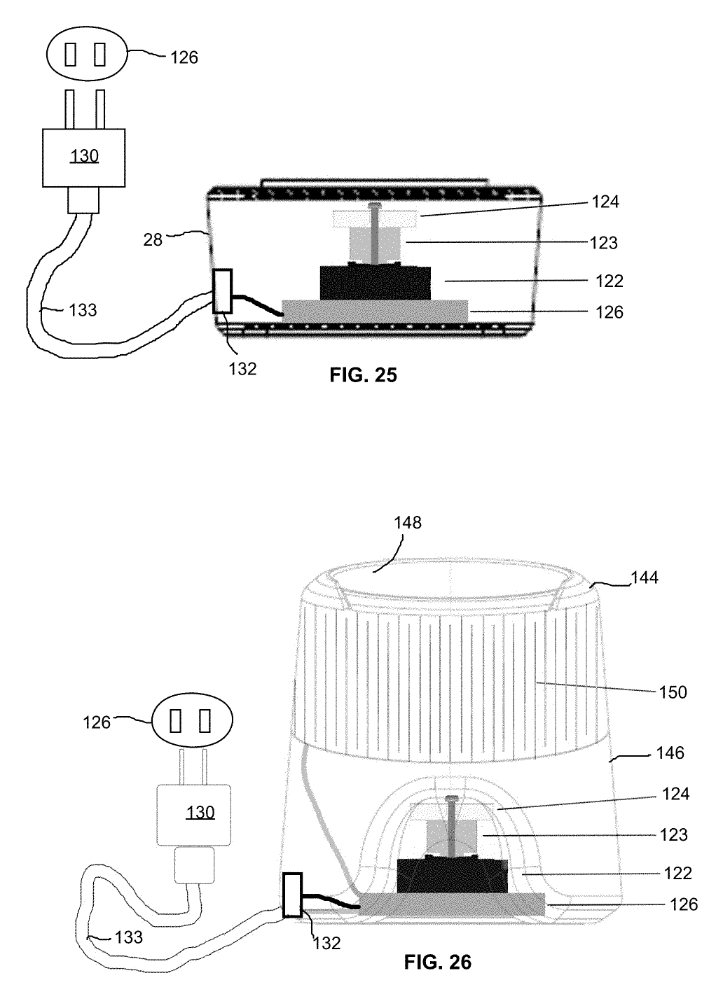

Accordingly, as shown in FIG. 25, the preferred magnetic stir base 28 has an electric motor 122, a magnet 124 operably connected to the electric motor 122, for example held by rotor 123, and configured to magnetically hold and spin the magnetic stirrer 26, a source of electrical power 126 for driving the electric motor 122, and a switch 128 for turning the electric motor 122 on and off. The magnet 124 may be a single bar magnet, or a combination of two or more magnets. Switch 128 may be a simple on/off switch or a variable switch to allow the user to control the speed of the electric motor 122 and by extension, the speed with which the magnetic stirrer 26 spins. The source of electrical power 126 may include one or more user replaceable batteries. As another example, the source of electrical power 126 may include one or more user replaceable or non-replaceable rechargeable batteries, and preferably also a means for charging the one or more rechargeable batteries. The means for charging the one or more rechargeable batteries may also be included within the magnetic stir base 28, such as for example an AC to DC transformer 130 and a suitable power connector 132, which is configured to be connected to an external cable 133 suitable for plugging into household electrical power. As another example, the means for charging the one or more rechargeable batteries may include a suitable power connector, such as a USB port 132, which is configured to be connected to an external cable 133 and transformer 130 suitable for plugging into household electrical power. What is important is that the magnetic stir base 28 is capable of holding the magnetic stirrer 26 against the floor 120 inside of the liquid compartment 22 when the magnetic stir base 28 is attached to the bottom of the liquid compartment 22, and to spin the magnetic stirrer 26 when the switch 128 is turned on.

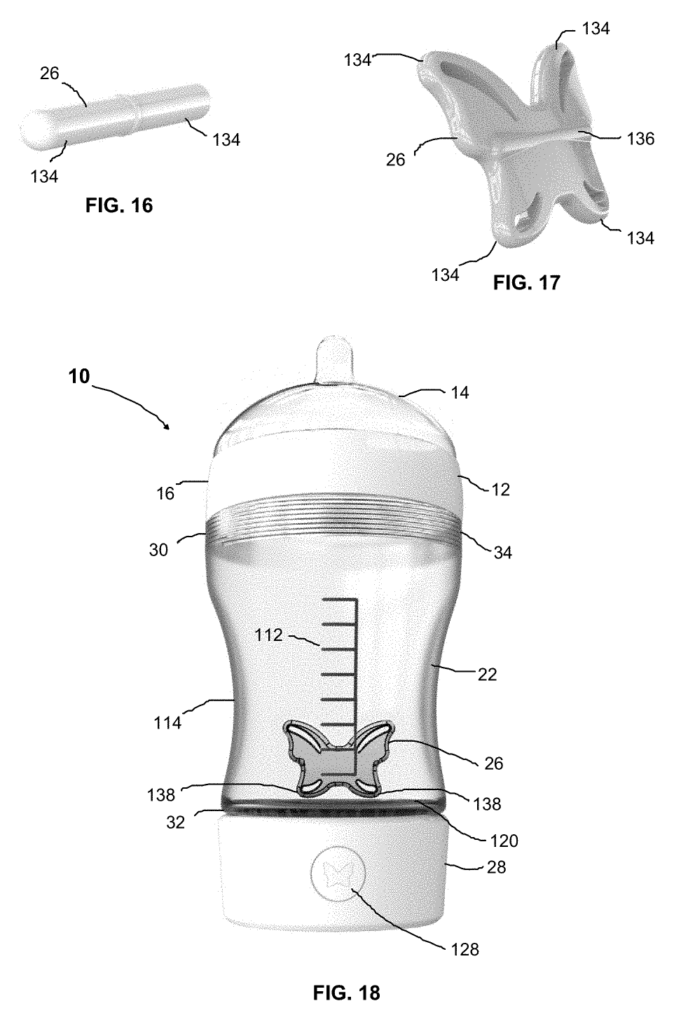

One example of a magnetic stirrer 26 is shown in FIG. 16, as an elongate, substantially cylindrical bar, with a raised ridge protruding about its middle, presenting two stirring arms 134. This type of magnetic stirrer 26 comprises one or more bar magnets encased in a plastic casing.

Another example of a magnetic stirrer 26 according to an embodiment of the present invention is shown in FIG. 17. The magnetic stirrer 26 shown is shaped to resemble a butterfly. However, other shapes representing other things is contemplated, including for example a profile of a muscle man flexing his arms, or a medical symbol, such as a caduceus. Preferably, the magnetic stirrer 26 may be formed from plastic, rubber, or rubber-like material, such as for example silicone, to have length and width dimensions sized to be larger than the largest dimension defined by gate openings 68 in the soluble mix compartment 18, to prevent the magnetic stirrer 26 from passing through the gate openings 68 when the top and bottom gates 46, 48, and/or the top and bottom pod gates 92, 94 are open. In the case of the butterfly shaped magnetic stirrer 26 shown in FIG. 17, the wings of the butterfly are preferably shaped to present four stirring arms 134. An elongate substantially cylindrical bar magnet 136 is encased in the plastic, rubber, or rubber-like material, such as for example silicone, substantially along a centerline of the magnetic stirrer 26. As will be appreciated, the magnetic stirrer 26 of FIG. 18 will be magnetically held, and spun, laying horizontally against the floor 120 of the liquid compartment 22 by the magnetic stir base 28.

However, according to another embodiment of the present invention, the magnetic stirrer 26 may be configured to be held and spun standing up vertically from the floor 120 of the liquid compartment 22, as shown in FIG. 18. According to this embodiment, the magnets will be positioned away from the centreline of the magnetic stirrer 26 to the bottom edge 138 of the magnetic stirrer 26, and the bottom edge 138 will be shaped to stand vertically up from the floor 120 of the liquid compartment 22. It is believed that configuring the magnetic stirrer 26 in this way to stand vertically up from the floor 120 may be aesthetically appealing to some users.

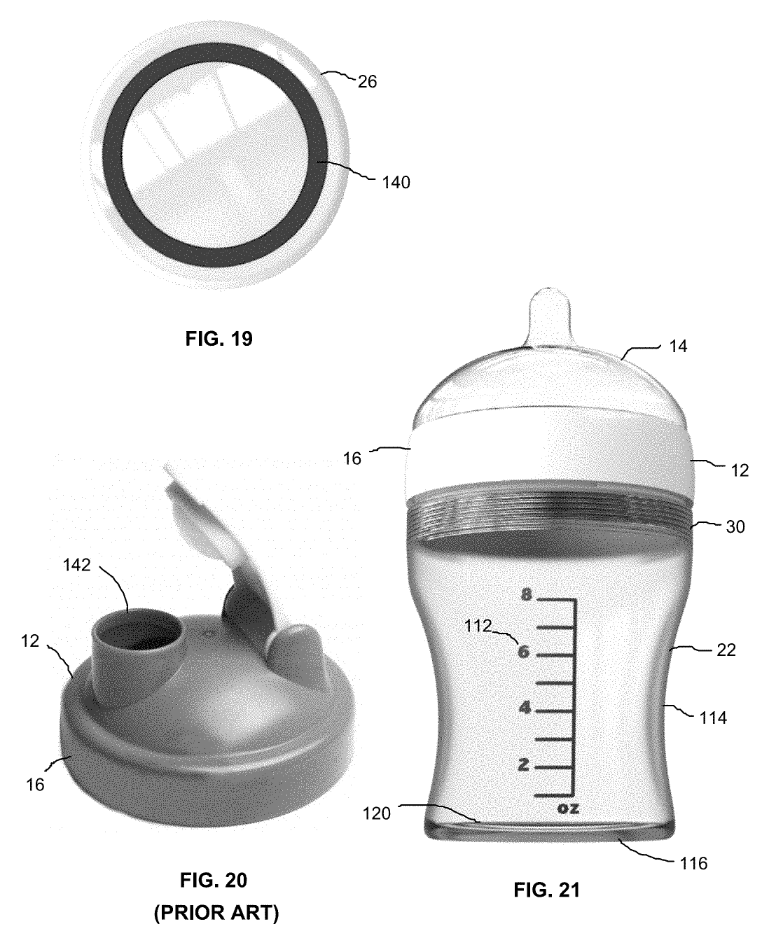

As best seen in FIG. 19, an anti-skid surface, such as for example an anti-skid ring 140, pad, or the like may be provided on bottom of the magnetic stir base 28, to help prevent the compartmentalized mixing container 10 from sliding on smooth or wet surfaces. The anti-skid ring 140 may be attached to the magnetic stir base 28 using any known method, including with adhesive, interference fit, or co-molding. Preferably, the anti-skid ring 140 may be made from rubber, or a rubber-like material selected for its ability to resist sliding on common surfaces on which the compartmentalized mixing container 10 may be rested.

As noted above, the compartmentalized mixing container 10 is not limited to baby bottles, but includes sports bottles, and other portable vessels for containing liquids, as well as food containers. Accordingly, the lid 12, may omit the nipple 14, and have instead, for example, a spout or opening 142, or the like through which the user may drink the liquid mix contained in the compartmentalized mixing container 10. An example of a prior art lid 12 having an opening 142 is shown in FIG. 20. All such embodiments are comprehended by the present invention. What is important is that the lid 12 is removably attachable to the soluble mix compartment 18, and enables drinking of the liquid mix contained inside the compartmentalized mixing container 10, after the soluble mix 20 has been released from the soluble mix compartment 18 into the liquid 24 stored in the liquid compartment 22, and mixed, preferably for a duration sufficient to dissolve substantially all of the soluble mix 20.

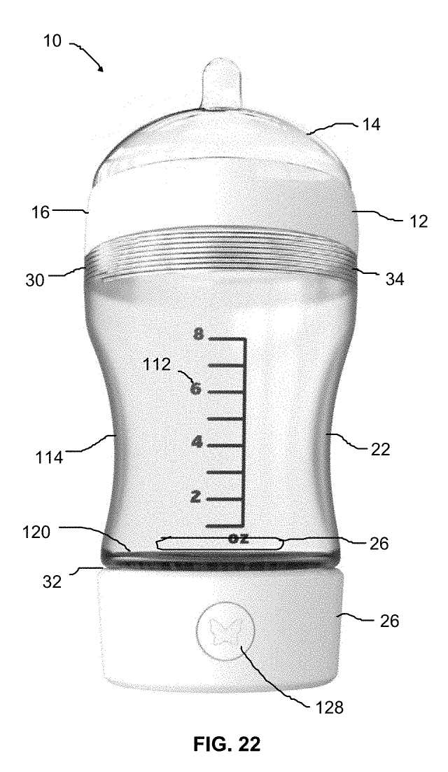

Having described the major components of various embodiments of the compartmentalized mixing container 10, it may now be appreciated that the components may be made to be modular, and used together as a system. For example, the lid 12 may be connected directly to the liquid compartment 22, without the intervening soluble mix compartment 18, the magnetic stirrer 26, and the magnetic stir base 28, as shown in FIG. 21. In this configuration, the compartmentalized mixing container 10 preferably may take the form of a typical baby bottle. Alternately, the magnetic stirrer 26 may be provided in the liquid compartment 22, and the lid 12 and magnetic stir base 28 connected as shown in FIG. 22, without the soluble mix compartment 18.

Furthermore, it is contemplated that embodiments of the soluble mix compartment 18 may be configured such that the bottom of the soluble mix compartment 18 may connect with conventional containers or bottles suitable for holding liquid 24, and the top of the soluble mix compartment 18 may connect to conventional lids 12. Accordingly, the soluble mix compartment 18 may be used to convert a conventional container or bottle into a compartmentalized mixing container 10. Such a compartmentalized mixing container 10 may be used without a magnetic stirrer 26 or magnetic stir base 28, in which case mixing may be affected by shaking, swirling, or repeatedly inverting the compartmentalized mixing container 10, after the soluble mix compartment 18 is opened. All such embodiments are comprehended by the present invention.

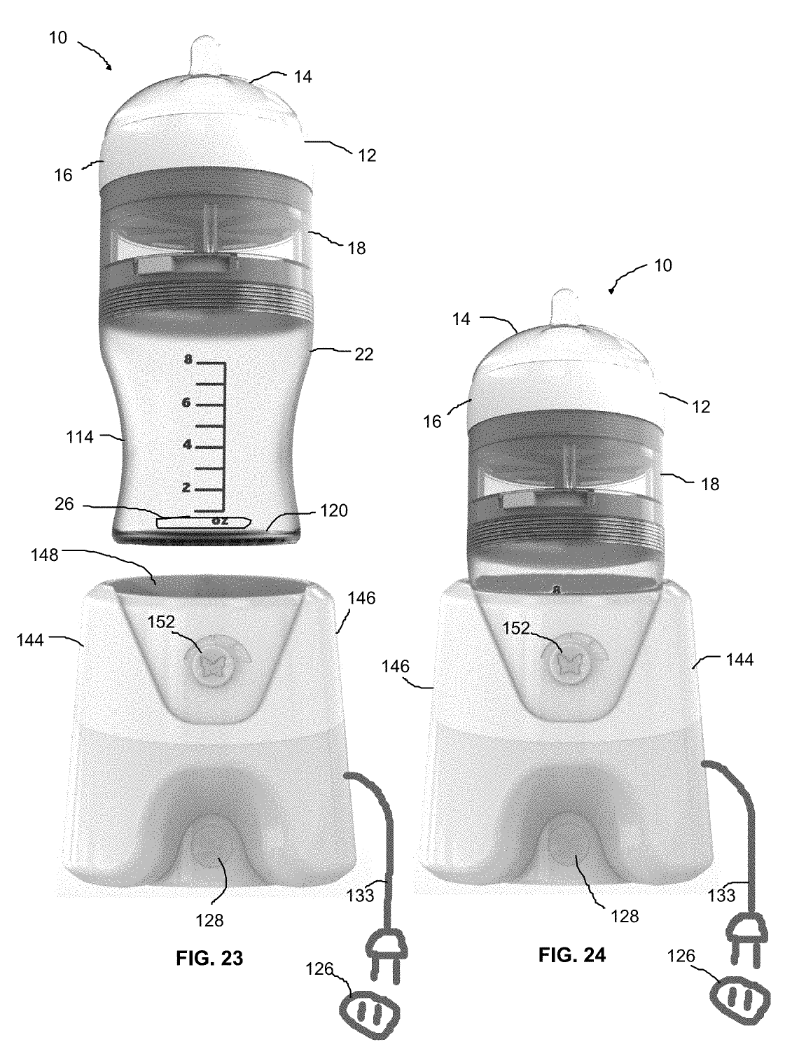

Additionally, the system may include a docking station 144 according to another embodiment of the present invention. For example, as shown in FIGS. 23 and 24, the compartmentalized mixing container 10 may be used without the magnetic stir base 28, and placed into the docking station 144. Accordingly, the docking station 144 preferably has a body 146 including a holder 148 sized and shaped to hold the liquid compartment 22 of the compartmentalized mixing container 10 therein.

As shown in FIG. 26, similar to the magnetic stir base 28 discussed above, the preferred docking station 144 is configured to magnetically hold the magnetic stirrer 26 to the floor 120 of the liquid compartment 22 and to spin the magnetic stirrer 26 to stir the liquid 24 and the soluble mix 20 released from the soluble mix compartment 18 into the liquid 24 to dissolve the soluble mix 20 and form the liquid mix so that it may be readied for drinking. Furthermore, it is contemplated that the magnetic stirrer 26 may be used to mix pureed food, such as for example pureed baby food, if the soluble mix compartment is not in use, or in embodiments that do not include the soluble mix compartment 18, such as food containers. Further still, it is contemplated that the magnetic stirrer 26 may be used to mix sauces and dressings (i.e. mixing powdered seasoning with oil, vinegar, water, milk, etc.), with or without using the soluble mix compartment 18. All such embodiments are comprehended by the present invention.

Accordingly, the preferred docking station 144 has an electric motor 122, a magnet 124 operably connected to the electric motor 122, for example held by rotor 123, and configured to magnetically hold and spin the magnetic stirrer 26, a source of electrical power 126 for driving the electric motor 122, and a switch 128 for turning the electric motor 122 on and off. The magnet 124 may be a single bar magnet, or a combination of two or more magnets. The source of electrical power 126 may include one or more user replaceable batteries. As another example, the source of electrical power 126 may include one or more user replaceable or non-replaceable rechargeable batteries, and preferably also a means for charging the one or more rechargeable batteries. The means for charging the one or more rechargeable batteries may also be included within the docking station 144, such as for example an AC to DC transformer 130 and a suitable power connector, which is configured to be connected to an external cable 133 suitable for plugging into household electrical power. As another example, the means for charging the one or more rechargeable batteries may include a suitable power connector, such as a USB port 132, which is configured to be connected to an external cable 133 and transformer 130 suitable for plugging into household electrical power. As yet a further example, the source of electrical power 126 may include an external cable 133 suitable for plugging directly into household electrical power as shown in FIGS. 23 and 24. What is important is that the docking station 144 is capable of holding the magnetic stirrer 26 against the floor 120 inside of the liquid compartment 22 when the compartmentalized mixing container 10 is placed in the holder 148, and to spin the magnetic stirrer 26 when the switch 128 is turned on.

According to a further embodiment of the present invention, the docking station 144 may also include a means for heating the compartmentalized mixing container 10 to warm its contents when placed in the holder 148. By way of example, the means for heating may include one or more heating elements 150 positioned in the holder 148, preferably controlled by a variable switch 152 which allows for temperature regulation. Preferably, the heating elements 150 may be arranged in the body 146 to heat the sides of the liquid compartment 22. It will be appreciated that variable switch 152, may be substituted with a simple on/off switch according to other embodiments of the present invention. Preferably, the docking station 144 may use household electrical power as a source of electrical power 126 for the one or more heating elements 150. Alternately, the docking station 144 may use rechargeable or replaceable batteries as a source of electrical power 126.

While reference has been made to various preferred embodiments of the invention other variations, implementations, modifications, alterations and embodiments are comprehended by the broad scope of the appended claims. Some of these have been discussed in detail in this specification and others will be apparent to those skilled in the art. For example, although the above examples describe the top and bottom gates 46, 48 of the soluble mix compartment 18, and the top and bottom pod gates 92, 94 as being opened and closed by rotatably sliding to align or misalign gate openings 68, it will now be appreciated that their opening and closing may be effected by linear sliding to align or misalign gate openings 68. As another example, although the above examples describe the lid 12, soluble mix compartment 18, liquid compartment 22, and magnetic stir base 28 as being substantially cylindrical in shape, it will now also be appreciated that the invention is not limited to any particular shape, but may include shapes defining a rectilinear volume, including having square, rectangular, and other polygon-shaped cross-sections. Those of ordinary skill in the art having access to the teachings herein will recognize these additional variations, implementations, modifications, alterations and embodiments, all of which are within the scope of the present invention, which invention is limited only by the appended claims.

We claim:

1. A soluble mix compartment substantially as shown and described.

2. A compartmentalized mixing container substantially as shown and described.

3. A system for compartmentalizing a soluble mix and a liquid, and stirring the soluble mix and the liquid into a liquid mix to allow a user to drink the liquid mix, substantially as shown and described.
